(19) United States
(12) Patent Application Publication
(10) Pub. No.: US 2026/0340040 A1
(43) Pub. Date: Oct. 29, 2026

(54) Method and System for Automatically Generating Semantic Data for Task Planning

(71) Applicant: IUCF-HYU (Industry-University Cooperation Foundation Hanyang University), Seoul (KR)

(72) Inventors: Yoonseon OH, Seoul (KR); Soojin JEONG, Seoul (KR); Seongwan BYEON, Seoul (KR)

(73) Assignee: IUCF-HYU (Industry-University Cooperation Foundation Hanyang University), Seoul (KR)

(21) Appl. No.: 19/540,374

(22) Filed: Feb. 13, 2026

(30) Foreign Application Priority Data
Feb. 20, 2025 (KR) 10-2025-0022215

(51) Int. Cl. G06F 16/903; G06F 16/9035; G06F 16/906

(52) U.S. Cl. CPC G06F 16/90335; G06F 16/9035; G06F 16/906

(57) ABSTRACT

Disclosed is a method and system for automatically generating semantic data for task planning. An automated data generation method for task planning performed by a data generation system may include receiving, as input, task planning data including a subgoal that includes an action and an object; and generating new task planning data for performing task planning through semantic-driven data augmentation using the input task planning data.

### CROSS-REFERENCE TO RELATED APPLICATION

This application claims the priority benefit of Korean Patent Application No. 10-2025-0022215, filed on Feb. 20, 2025, in the Korean Intellectual Property Office, the disclosure of which is hereby incorporated by reference.

### BACKGROUND

### 1. Field of the Invention

The following description relates to technology for generating data for training of a model.

### 2. Description of the Related Art

Natural language is the most intuitive method for humans to interact with robots, and research on understanding natural language instructions of task planning has been continuously explored. With the recent advancement of large language models, active research is being conducted using commonsense understanding and natural language processing capability of large language models for task planning. Despite this advancement, current models still struggle to achieve the optimal performance due to the lack of comprehensive and open datasets for task planning. 20 robots were used for 7 months to collect a large amount of data for task planning of a robot, which shows the limitation that a lot of time and cost are required to collect the large amount of data.

### SUMMARY

Example embodiments may provide a method and system for generating a large amount of data from a small amount of data by replacing a method that requires a large amount of time and a large number of agents to train a high-level task planner model.

Example embodiments may provide an automated data generation method and system through commonsense verification through semantic-driven data augmentation and a large language model.

Example embodiments may provide an automated data augmentation method and system for collecting a large amount of high-quality data required to train a learning model from a small initial dataset to perform task planning.

According to an aspect, there is provided an automated data generation method for task planning performed by a data generation system, the automated data generation method including receiving, as input, task planning data including a subgoal that includes an action and an object; and generating new task planning data for performing task planning through semantic-driven data augmentation using the input task planning data.

The generating may include replacing the object with another object based on semantic information that includes a location, a category, and a property of a task-relevant object in the input task planning data.

The generating may include filtering the object in the input task planning data based on relevance of the object with the semantic information, sampling a replaceable object for the filtered object, and generating the new task planning data using the sampled replaceable object.

The generating may include simultaneously generating different levels of instructions to perform a task from the generated new task planning data through a large language model.

The large language model may be used through a few-shot example that includes task planning data, instructions, and commonsense verification results.

The generating may include determining whether tasks of the simultaneously generated different levels of instructions are commonsense.

The generating may include classifying the tasks as data for training a task planner model when the tasks are determined to be commonsense.

According to an aspect, there is provided a non-transitory computer-readable recording medium storing a computer program to execute an automated data generation method for task planning performed by a data generation system, wherein the automated data generation method include receiving, as input, task planning data including a subgoal that includes an action and an object; and generating new task planning data for performing task planning through semantic-driven data augmentation using the input task planning data.

According to an aspect, there is provided a data generation system including a data input unit configured to receive, as input, task planning data including a subgoal that includes an action and an object; and a data generation unit configured to generate new task planning data for performing task planning through semantic-driven data augmentation using the input task planning data.

The data generation unit may be configured to replace the object with another object based on semantic information that includes a location, a category, and a property of a task-relevant object in the input task planning data.

The data generation unit may be configured to filter the object in the input task planning data based on relevance of the object with the semantic information, to sample a replaceable object for the filtered object, and to generate the new task planning data using the sampled replaceable object.

The data generation unit may be configured to simultaneously generate different levels of instructions to perform a task from the generated new task planning data through a large language model.

The large language model may be used through a few-shot example that includes task planning data, instructions, and commonsense verification results.

The data generation unit may be configured to determine whether tasks of the simultaneously generated different levels of instructions are commonsense.

The data generation unit may be configured to classify the tasks as data for training a task planner model when the tasks are determined to be commonsense.

According to some example embodiments, it is possible to acquire a large amount of high-quality datasets from a small number of initial datasets.

According to some example embodiments, it is possible to save the cost of human labor by directly generating data and by eliminating the need to label instructions.

Compared to other conventional arts, it is possible to acquire a high-quality dataset through reduction in time cost required to acquire a large amount of datasets and a commonsense inference review process.

According to some example embodiments, it is easy for learning of a task planner from a large amount of data about the generate task sequence.

Although a dataset for simulation-based task sequence is generated, the utilization scalability is excellent since data generated in the real world is immediately applicable.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 illustrates the general operation of generating task planning according to an example embodiment;

FIG. 2 illustrates a task planner model according to an example embodiment;

FIG. 3 illustrates a data augmentation operation according to an example embodiment;

FIG. 4 is a block diagram illustrating a data generation system according to an example embodiment; and

FIG. 5 is a flowchart illustrating an automated data generation method according to an example embodiment.

### DETAILED DESCRIPTION

Hereinafter, example embodiments will be described in detail with reference to the accompanying drawings.

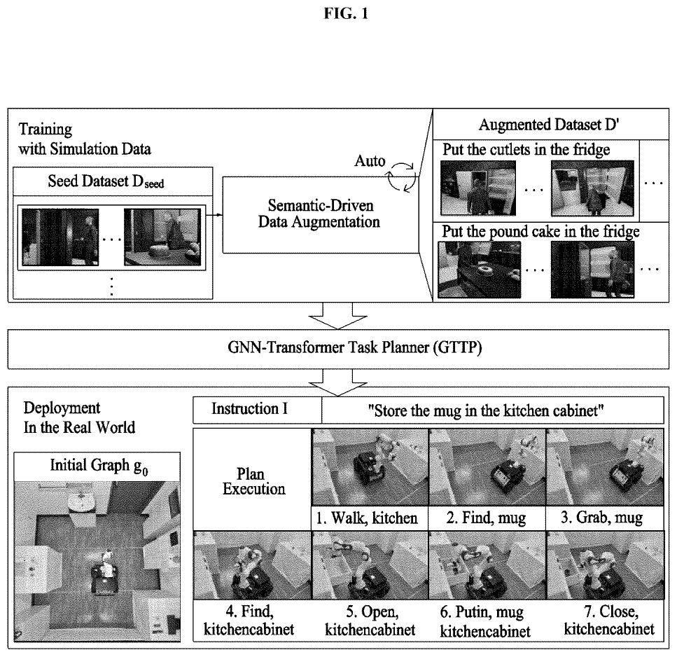

FIG. 1 illustrates the general operation of generating task planning according to an example embodiment.

The top of FIG. 1 shows an automatic data augmentation procedure using a small seed dataset based on semantic information of a task in a simulation environment. A data generation system may train a task planner (GNN-Transformer Task Planner (GTTP)) model using an augmented dataset. Here, the task planner model may be configured based on a graph neural network (GNN) and a transformer model. The bottom of FIG. 1 shows an inference procedure of generating a task plan using a goal instruction of a task and an initial scene graph through the trained task planner model. The task planner model may extract feature information of an object important for a task from a state graph and an instruction through the graph neural network. The task planner model may generate a task plan that considers information of previous states through a transformer structure. The task planner model may determine the feasibility of a predicted next plan and a plan completion time.

The task planner model may receive a scene graph that integrates semantic information on an encoded object through a text embedding module. Here, the semantic information is processed by the graph neural network to accommodate various numbers of objects, and is combined with the transformer model to consider past states. The task planner model may select a feasible high-level plan for execution.

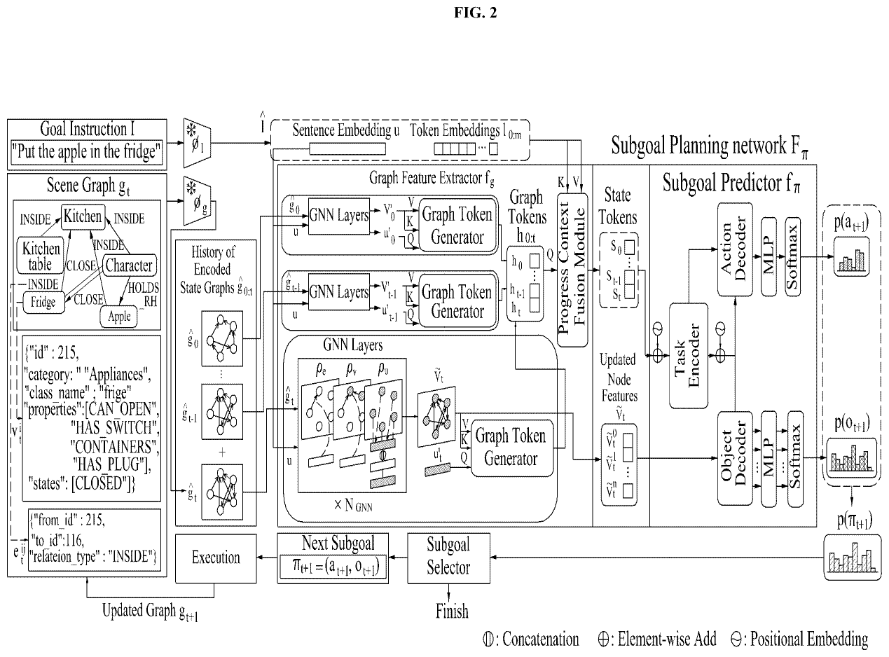

FIG. 2 illustrates a task planner model according to an example embodiment.

The example embodiment proposes a high-level robot task planning method based on natural language instructions. For convenience of description, household tasks in a complex environment are described as an example in FIG. 2. For example, when an agent receives a goal instruction “Put the chicken in the microwave,” the agent needs to walk to the kitchen, find and grab the chicken, open the microwave, and place the chicken inside. As such, the example embodiment aims to generate a high-level and interpretable subgoal.

Formally, a goal instruction may be represented by I. The state of an environment and a robot may be represented by a directed scene graph gₜ=( [symbol] , εₜ) at time t. Here, [symbol] and εₜ denote node and edge features, respectively. Each node

$${v}_{t}^{i} ∈ {𝒱}_{t}$$

may contain five types of knowledge including a unique identifier, a class name, a category, a property, and a state.
(1) The unique identifier (id) represents a unique value that is assigned to each object to distinguish each object from other objects within a graph by assigning a unique value to each object.
(2) The class name denotes a specific name of an object (e.g., apple).
(3) The category represents a broader classification group, such as appliances.
(4) The property describes the attribute of an object.
(5) The state represents a current state of an object.

A directed edge

$${e}_{t}^{ij} ∈ {ℰ}_{t}$$

represents a semantic relation between

$${v}_{t}^{i} and {v}_{t}^{j} .$$

The subgoal at time t is expressed as πₜ=(aₜ, oₜ). Here, aₜ∈ [symbol] and oₜ∈ [symbol] represent a robot action skill and a target object to which the robot action skill is to be applied, respectively. Here, an action skill set may be defined as A={Walk, Find, Open, Close, Grab, PutIn, PutBack, SwitchOn, SwitchOff, Finish}. An object set [symbol] is a set of all objects within a given environment, which is assumed to be fully observable. In an example embodiment, a task planner model for predicting an appropriate subgoal may be designed based on the goal instruction I and state graph history g_{0:t}={g₀, . . . , gₜ₋₁, gₜ}. The output of the task planner model at time t is a subgoal πₜ₊₁ to be performed at next time t+1.

A task planning process of the task planner model is described with reference to FIG. 2. A scene graph encoder φ_{g} and an instruction encoder φ_{I} may extract features from an environment and a natural language instruction, respectively. A subgoal planning network may predict the probability of action p(aₜ₊₁) and object p(oₜ₊₁) for next time step t+1 based on the history of encoded state graph ĝ_{0:t} and the encoded instruction Î. A subgoal selector may determine a feasible subgoal with the highest probability. This task planning process may be repeated until task completion is achieved.

To address an instruction-driven high-level task planning issue, the task planner model may be configured based on a transformer model and a graph neural network having the goal instruction I and the state graph history g_{0:t} as input. Here, the goal instruction I and the scene graph gₜ may be encoded by the instruction encoder φ_{I} and the scene graph encoder φ_{g}, respectively. Subsequently, the encoded goal instruction and scene graph may be input to the subgoal planning network [symbol] along with the history of a previous state graph, to estimate the probability distribution of potential subgoals based on the context of ongoing task sequence. Therefore, the subgoal selector may select a feasible subgoal πₜ₊₁ with the highest probability.

More specifically, each node

$${v}_{t}^{i}$$

and edge

$${e}_{t}^{ij}$$

in the scene graph gₜ may include semantic information on the environment in JSON format as shown in FIG. 2. The scene graph encoder φ_{g} may leverage text embedding models to transform the node

$${v}_{t}^{i}$$

and the edge

$${e}_{t}^{ij}$$

to 384-dimensional vectors, termed node feature

$${\hat{v}}_{t}^{i}$$

and edge feature

$${\hat{e}}_{t}^{ij} ,$$

respectively. The embedded scene graph ĝₜ may preserve the original graph structure, maintaining semantic information between objects.

The instruction encoder φ_{I} may generate an instruction feature Î including a sentence embedding u and a token embedding set l_{0:m} from instruction sentence I. Here, m denotes the number of tokens. In an example embodiment, Sentence-BERT may be adopted for both the scene graph encoder φ_{g} and a goal encoder φ_{I} to share the same latent space.

The subgoal planning network may process the history of the encoded state graph g_{0:t} and the encoded instruction feature Î to plan a subgoal πₜ₊₁. The subgoal planning network may include a graph feature extractor f_{g} and a subgoal predictor f_{π}.

The graph feature extractor may be configured to extract a state token that includes state information and a node feature that includes object information by combining the embedded scene graph and the sentence embedding u. The graph feature extractor may interpret both the encoded scene graph and the encoded instruction using GNN layers, a graph token generator, and a progress context fusion module. The graph feature extractor may use a GNN layer stack to extract task-relevant features from the history of the encoded state graph ĝ_{0:t} and the sentence embedding u. The graph feature extractor may design GNN layers using three update functions, ρₑ, ρᵥ, and ρᵤ.

The edge update function ρₑ may update edge information by combining the edge that concatenates an i^{th} node and a j^{th} node and a sentence embedding and then passing through a multi-layer perceptron (MLP) function. Then, the node update function ρᵥ may update node information based on an i^{th} node feature and an edge feature and a sentence embedding with neighboring nodes updated from a previous edge update function. Finally, the global update function ρᵤ may update a node feature and a sentence embedding.

The edge update function ρₑ may be formulated as follows.

$${\tilde{e}}_{t}^{ij} = {ρ}_{e} ( {\hat{v}}_{t}^{j} , {\hat{v}}_{t}^{j} , {\hat{e}}_{t}^{ij} , u ) = g ( {\hat{v}}_{t}^{i} ‖ {\hat{v}}_{t}^{j} ‖ {\hat{e}}_{t}^{ij} ‖ u )$$

Here, g(⋅) denotes the MLP function and ∥ denotes vector concatenation. Each updated edge

$${\tilde{e}}_{t}^{ij}$$

may aggregate information from the connected node and the provided sentence embedding u.

Likewise, the node feature

$${\tilde{v}}_{t}^{i}$$

may be updated by the node update function ρᵥ.

$${\tilde{v}}_{t}^{i} = {ρ}_{v} ( {\hat{v}}_{t}^{i} , {𝒩}_{t}^{i} , u ) = g ( {\hat{v}}_{t}^{i} ‖ \frac{1}{\vert {𝒩}_{t}^{i} \vert} {\sum }_{k ∈ {𝒩}_{t}^{i}} g ( {\hat{v}}_{t}^{k} ‖ {\tilde{e}}_{t}^{ki} ) ‖ u )$$

Here,

$${𝒩}_{t}^{i}$$

denotes a set of neighbor nodes of

$${v}_{t}^{i} .$$

The updated node

$${\tilde{v}}_{t}^{i}$$

may include surrounding environment information.

At last, the sentence embedding u may be inserted as a global feature of a graph, and may be updated by simply averaging all the updated nodes.

$${\tilde{u}}_{t} = {ρ}_{u} ( {\tilde{v}}_{t} , u ) = ℊ ( u ‖ \frac{1}{\vert {\tilde{v}}_{t} \vert} {Σ}_{i ∈ {\tilde{v}}_{t}} {\tilde{v}}_{t}^{i} )$$

Here, [symbol] denotes a set of updated node embeddings. In an example embodiment, the number of GNN layers N_{GNN} may be set as 3, and dimensions of the updated node, edge, and instruction feature may be reduced to 256, 128, and 64, respectively.

The graph feature extractor may pass graph features through GNN layers three times and then, may update graph information using cross-attention to emphasize features of objects having high goal relevance. The graph feature extractor may add a cross-attention layer called a graph token generator for each updated graph \tilde{g}ₜ. The graph token generator may use the updated sentence embedding ũₜ as query Q and may use updated node embeddings [symbol] as keys K and values V. A graph token hₜ is output from an initial time to a current time step, resulting in h_{0:t}=[h₀, . . . , hₜ]. Also, the agent needs to know which goal condition needs to be resolved for each state. For example, in an instruction “Go to the living room and turn the light off,” “the living room” needs to be emphasized in an earlier state, and “the light” needs to be focused in a later state within the state history. For this reason, the progress context fusion module may apply cross-attention that uses the graph token h_{0:t} as query and token embeddings l_{0:m} as keys and values. As a result, state tokens from the initial time to the current time step containing instructions and implicit information of the scene graph may be acquired from the graph feature extractor. The resultant state tokens s_{0:t} emphasize important instruction tokens for each state. Therefore, the task planner determines an appropriate subgoal in consideration of the progress context.

The subgoal predictor may select a subgoal containing information of a most appropriate action and a target object from historical state tokens and node embeddings updated by passing through GNN layers. The subgoal predictor may interpret historical state information to generate probability distributions, p(aₜ₊₁) and p(oₜ₊₁), for a next action and a next target object, respectively. The overall structure may be a modified version of vanilla transformer architecture. Initially, a task encoder uses a sequence of state tokens along with positional embeddings to generate task tokens that encode historical information of an ongoing task. These task tokens, through element-wise addition for state tokens and positional embeddings, may be input to both a task decoder and an object decoder to provide sequential history features. The task decoder may take state tokens and may output the task probability for each input state through MLP and softmax layer. In inference, the task planner may use only the probability p(aₜ₊₁) from the current state token sₜ. The object decoder may use the updated node embeddings [symbol] to find an important target object among them.

To predict a next subgoal, the subgoal selector may determine the probability of the next subgoal that includes an action and a target object, with the highest probability in the next time step, from a previous subgoal predictor. The subgoal selector may determine the next subgoal based on the following equation.

πₜ₊₁=arg max_{π∈Π}_{_{f}}p(πₜ₊₁).

Here, Π_{f} denotes a set of subgoals successfully executable in a current state. In simulations, the feasibility of each subgoal may be verified using a specific simulator (e.g., VirtualHome). The subgoal selector may determine the feasibility of a subgoal executed by the agent according to predefined rules for each action. For example, a predefined rule may be set. ‘The agent should not be holding any object to perform a grab action.’ When the subgoal selector determines that the subgoal is executable, that is, when the next subgoal πₜ₊₁ is determined, the state may be updated to gₜ₊₁. Therefore, this process may be iteratively repeated in a single scenario until the predicted next action aₜ₊₁ is completed or until a feasible action may not be found.

Node dropout and a loss function are described. The data generation system may introduce a node dropout method to cope with graphs of various sizes in a learning process of a task planner. The data generation system may categorize an important object and background objects from an initial graph and aground truth task plan. Starting with the initial scene graph g₀ and the ground truth task plan, the data generation system may classify objects in g₀, [symbol] , into essential objects related to the plan, [symbol] and a set of background objects, [symbol] . By randomly dropping out 30%, 60%, and 90% of [symbol] , node-dropped graph sequences may be added to a training set, which may improve the robustness of the task planner against the change in background objects. For training, cross-entropy may be used as the loss function by the task planner as follows.

[symbol]

=α [symbol] +β

[symbol]

Here, α and β denote coefficients of the loss function. L_{action} and L_{object} denote loss functions related to an action and an object, respectively.

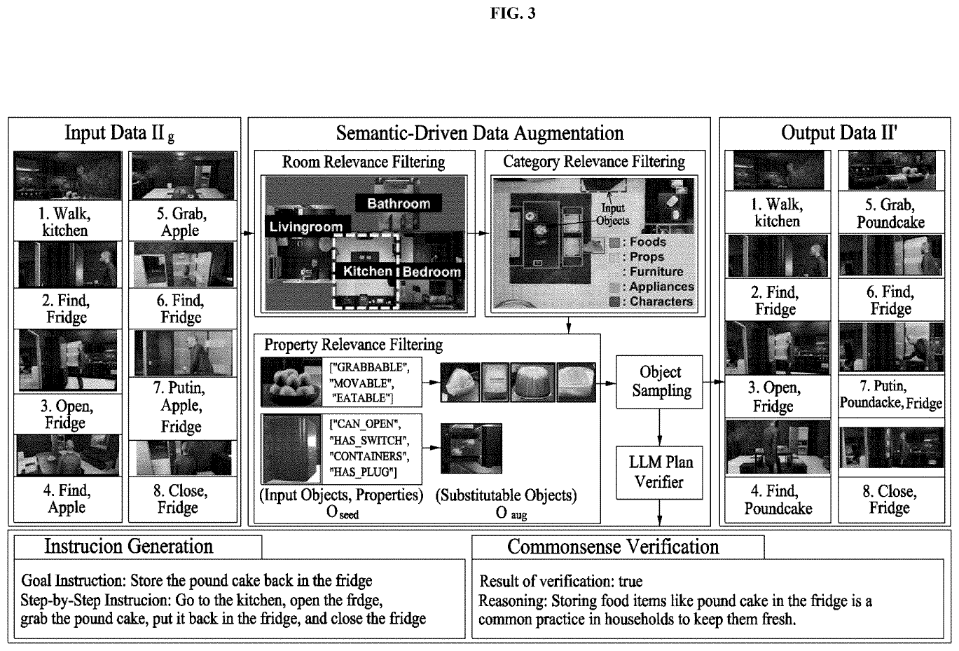

FIG. 3 illustrates a data augmentation operation according to an example embodiment.

The data generation system may propose an automated data augmentation pipeline in consideration of semantic information of objects to augment a seed dataset that is a small hand-crafted task dataset. Also, the data generation system may propose a large language model (LLM)-based automatic plan verification and instruction generation method that not only generates language instructions appropriate for augmented task plans but also evaluates reasonableness of the plans through commonsense reasoning. The seed dataset is denoted by

$${D}_{seed} = \{ ( {Π}_{ℊ}^{i} , {ℊ}_{0}^{i} \vert i = 1 , 2 , … , N \} .$$

### Here,

$${Π}_{ℊ}^{i}$$

denotes a sequence of subgoals, and

$${ℊ}_{0}^{i}$$

denotes an initial scene graph of an i^{th} data point. The data generation system may collect a plurality of (e.g., seven) seed tasks from a specific dataset and a plurality of (e.g., six) seed tasks from its own task dataset. The data generation system may acquire an additional seed task by combining or diving them. As a result, the seed dataset may be constructed with N=45.

FIG. 3 shows an automated semantic augmentation process in which an input task is “Put the apple in the fridge,” and a newly generated task is “Store the pound cake in the fridge.” Assuming that task planning data to put the apple in the fridge is input, the data generation system may have a task planning sequence with a subgoal in the form of [action]<object>, such as [walk]<kitchen> . . . [grab]<apple> . . . [close]<fridge>, as data. The data generation system may identify a room in which the task occurred, category and property of an object related to the task from the task planning data, and may perform sampling for an identically replaceable object. For example, the object related to the task may be an apple, and an object that may replace the apple may be pound cake having the same category of foods and the property of “GRABBABLE,” “MOVABLE,” and “EATABLE” in the kitchen of the same room.

To scale up the seed dataset, the data generation system may initially select a data point Π_{g}={π₁, . . . , πᵣ}. Here, T denotes the length of the plan, and πₜ(aₜ, oₜ). Let a set of all objects within Π_{g} be

$${O}_{seed} = \{ {o}^{t} \vert {π}_{t} = ( {a}_{t} , {o}_{t} ) , {π}_{i} ∈ {Π}_{ℊ} \} := \{ {o}_{1}^{s} , … , {o}_{n}^{s} \} .$$

Here, n denotes the number of unique objects in Π_{g}. Any object o^{s}∈O_{seed} may be replaced with another object in consideration of semantic information, such as a location, category, and property. Replacement may be allowed only when a substitute object is located in the same room and shares the identical category and property with o^{s}. This potential replacement object set may be denoted as O_{avg}(o^{s}). This approach maintains contextual relevance and consistency with original data point characteristics in augmented data. Then, a set of objects

$${O}^{′} = \{ {o}_{1}^{′} , … , {o}_{n}^{′} \}$$

may be sampled, and each

$${o}_{i}^{′}$$

may be sampled from

$${O}_{aug} ( {o}_{i}^{s} ) .$$

The total number of distinct sampling combinations may be represented as

$${Π}_{i = 1}^{n} \vert {O}_{aug} ( {o}_{i}^{s} ) \vert .$$

The data generation system may generate a new plan Π′ by sampling O′ and then replacing each

$${o}_{i}^{s}$$

of Π_{g} with

$${o}_{i}^{′} .$$

More formally, the revised plan is

$${Π}^{′} = \{ {π}_{1}^{′} , ⋯ , {π}_{T}^{′} \} .$$

### Here, if

$${o}_{t} = {o}_{k}^{s} , {π}_{t}^{′} = ( {a}_{t} , {o}_{k}^{′} ) .$$

The sampling process may be repeated for Nₛₐₘₚₗₑ. In an example embodiment,

$${N}_{sample} = min ( {Π}_{i = 1}^{n} \vert {O}_{aug} ( {o}_{i}^{s} ) \vert , 20 )$$

may be set in 50 different types of environments.

The data generation system may propose an LLM plan verifier, a module that generates natural language instructions to explain an augmented task plan and to verify whether the plan is suitable for everyday household robotic tasks. For example, as shown in FIG. 3, the given task plan is annotated in two formats, a goal instruction, “Store the pound cake back in the fridge,” and a step-by-step instruction, “Go to the kitchen, open the fridge, grab the pound case, put it back in the fridge, and close the fridge.” However, not all augmented plans are practical or typical. For example, the plan verifier may exclude a task annotated as “Microwave chocolate bar” due to the fact that “Microwaving a candy bar is not a typical household task, and could be potentially dangerous if it involves wrappers or ingredients that are unsuitable for microwaving.” Through this, unreasonable data points may be automatically excluded.

The LLM plan verifier may employ a large language model in a few-shot learning method. A prompt designed with a Chain-of-Thought (CoT) method may generate both verification decision and reasoning behind the verification decision. Each prompt may begin with a guidance sentence to summarize and evaluate a robot task plan. This is followed by few-shot examples that include a task plan, its natural language instruction I, and commonsense verification results (true or false). The dataset may include output from the LLM plan verifier only when the plan is verified as true. In an example embodiment, a large language model (e.g., GPT-4O model) configured with a plurality of (e.g., three) few-shot examples may be employed. A total number of 14,000 datasets including various categories, such as object relocation, appliance operation, cooking foods, and object retrieval, may be generated.

Such a large language model may simultaneously output language instructions below along with commonsense reasoning for a task. The data generation system may generate “Store the pound cake in the fridge” as the goal instruction containing implicit information through the LLM plan verifier, and may generate “Go to the kitchen, open the fridge, grab the pound cake, put it back in the fridge, and close the fridge” as the step-by-step instruction containing detailed information. The data generation system may perform reasoning of “Storing food items like pound cake in the fridge is a common practice in households to keep them fresh.” due to the fact that data for the task sequence is valid for commonsense reasoning through commonsense verification, and may classify inference results as data that is determined to be commonsense and usable.

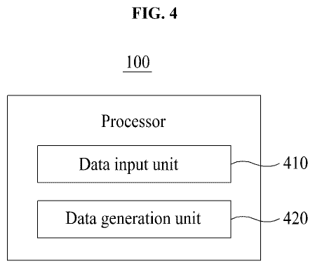

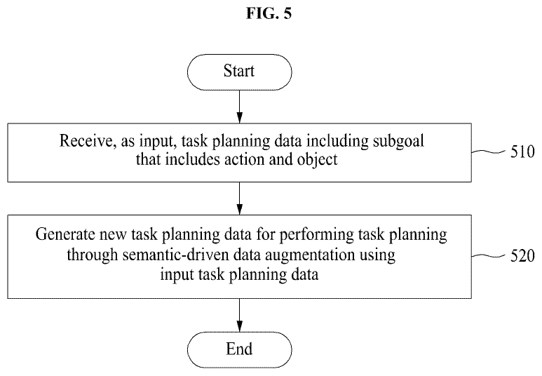

FIG. 4 is a block diagram illustrating a data generation system according to an example embodiment, and FIG. 5 is a flowchart illustrating an automated data generation method according to an example embodiment.

A processor of a data generation system 100 may include a data input unit 410 and a data generation unit 420. The components of the processor may be representations of different functions performed by the processor in response to a control instruction provided from a program code stored in the data generation system 100. The processor and the components of the processor may control the data generation system 100 to perform operations 510 to 520 included in the automated data generation method of FIG. 5. The processor and the components of the processor may be implemented to execute an instruction according to a code of at least one program and a code of an operating system (OS) included in a memory.

The processor may load a program code stored in a file of a program for the automated data generation method to the memory. For example, when the program is executed on the data generation system 100, the processor may control the data generation system 100 to load the program code from the file of the program to the memory under control of the OS. Here, each of the data input unit 410 and the data generation unit 420 may be different functional representations of the processor to perform operations 510 to 520 after executing an instruction of a corresponding portion in the program code loaded to the memory.

In operation 510, the data input unit 410 may receive, as input, task planning data including a subgoal that includes an action and an object.

In operation 520, the data generation unit 420 may generate new task planning data for performing task planning through semantic-driven data augmentation using the input task planning data. The data generation unit 420 may replace the object with another object based on semantic information that includes a location, a category, and a property of a task-relevant object in the input task planning data. The data generation unit 420 may filter the object in the input task planning data based on relevance of the object with the semantic information, and may sample a replaceable object for the filtered object. The data generation unit 420 may generate the new task planning data using the sampled replaceable object. The data generation unit 420 may simultaneously generate different levels of instructions to perform a task from the generated new task planning data through a large language model. The data generation unit 420 may determine whether tasks of the simultaneously generated different levels of instructions are commonsense. The data generation unit 420 may classify the tasks as data for training a task planner model when the tasks are determined to be commonsense.

The apparatuses described herein may be implemented using hardware components, software components, and/or combination of the hardware components and the software components. For example, the apparatuses and components described herein may be implemented using one or more general-purpose or special purpose computers, such as, for example, a processor, a controller, an arithmetic logic unit (ALU), a digital signal processor, a microcomputer, a field programmable gate array (FPGA), a programmable logic unit (PLU), a microprocessor, or any other device capable of responding to and executing instructions in a defined manner. A processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that the processing device may include multiple processing elements and/or multiple types of processing elements. For example, the processing device may include multiple processors or a processor and a controller. In addition, different processing configurations are possible, such as parallel processors.

The software may include a computer program, apiece of code, an instruction, or some combinations thereof, for independently or collectively instructing or configuring the processing device to operate as desired. Software and/or data may be embodied in any type of machine, component, physical equipment, virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable storage mediums.

The methods according to example embodiments may be configured in a form of program instructions performed through various computer methods and recorded in non-transitory computer-readable media. The media may include, alone or in combination with program instructions, data files and data structures. The program instructions recorded in the media may be specially designed and configured for the example embodiments or may be known and available to those skilled in the computer software art. Examples of the media may include magnetic media such as hard disks, floppy disks, and magnetic tapes; optical media such as CD-ROM and DVDs; magneto-optical media such as floptical disks; and hardware devices that are specially configured to store and perform program instructions, such as ROM, RAM, flash memory, and the like. Examples of the program instructions include machine language codes as produced by a compiler and advanced language codes executable by a computer using an interpreter.

Although the example embodiments are described with reference to some specific example embodiments and accompanying drawings, it will be apparent to one of ordinary skill in the art that various alterations and modifications in form and details may be made in these example embodiments without departing from the spirit and scope of the claims and their equivalents. For example, suitable results may be achieved if the described techniques are performed in different order, and/or if components in a described system, architecture, device, or circuit are combined in a different manner, and/or replaced or supplemented by other components or their equivalents.

Therefore, other implementations, other example embodiments, and equivalents of the claims are to be construed as being included in the claims.

What is claimed is:

1. An automated data generation method for task planning performed by a data generation system, the automated data generation method comprising:
receiving, as input, task planning data including a subgoal that includes an action and an object; and
generating new task planning data for performing task planning through semantic-driven data augmentation using the input task planning data.

2. The automated data generation method of claim 1, wherein the generating comprises replacing the object with another object based on semantic information that includes a location, a category, and a property of a task-relevant object in the input task planning data.

3. The automated data generation method of claim 2, wherein the generating comprises filtering the object in the input task planning data based on relevance of the object with the semantic information, sampling a replaceable object for the filtered object, and generating the new task planning data using the sampled replaceable object.

4. The automated data generation method of claim 1, wherein the generating comprises simultaneously generating different levels of instructions to perform a task from the generated new task planning data through a large language model.

5. The automated data generation method of claim 4, wherein the large language model is used through a few-shot example that includes task planning data, instructions, and commonsense verification results.

6. The automated data generation method of claim 4, wherein the generating comprises determining whether tasks of the simultaneously generated different levels of instructions are commonsense.

7. The automated data generation method of claim 6, wherein the generating comprises classifying the tasks as data for training a task planner model when the tasks are determined to be commonsense.

8. A non-transitory computer-readable recording medium storing a computer program to execute an automated data generation method for task planning performed by a data generation system, wherein the automated data generation method comprises:
receiving, as input, task planning data including a subgoal that includes an action and an object; and
generating new task planning data for performing task planning through semantic-driven data augmentation using the input task planning data.

9. A data generation system comprising:
a data input unit configured to receive, as input, task planning data including a subgoal that includes an action and an object; and
a data generation unit configured to generate new task planning data for performing task planning through semantic-driven data augmentation using the input task planning data.

10. The data generation system of claim 9, wherein the data generation unit is configured to replace the object with another object based on semantic information that includes a location, a category, and a property of a task-relevant object in the input task planning data.

11. The data generation system of claim 10, wherein the data generation unit is configured to filter the object in the input task planning data based on relevance of the object with the semantic information, to sample a replaceable object for the filtered object, and to generate the new task planning data using the sampled replaceable object.

12. The data generation system of claim 9, wherein the data generation unit is configured to simultaneously generate different levels of instructions to perform a task from the generated new task planning data through a large language model.

13. The data generation system of claim 12, wherein the large language model is used through a few-shot example that includes task planning data, instructions, and commonsense verification results.

14. The data generation system of claim 13, wherein the data generation unit is configured to determine whether tasks of the simultaneously generated different levels of instructions are commonsense.

15. The data generation system of claim 14, wherein the data generation unit is configured to classify the tasks as data for training a task planner model when the tasks are determined to be commonsense.
